(19) United States
(12) Patent Application Publication
(10) Pub. No.: US 2026/0232124 A1
(43) Pub. Date: Aug. 13, 2026

(54) TABLE CADDY INCORPORATING ELECTRONIC DEVICE SUPPORT

(71) Applicant: SC Supplies, LLC, Bath, PA (US)

(72) Inventors: Ralph Caiazzo, Bath, PA (US); Britney Rae Martin, Bath, PA (US); Edmond J. Seifried, Easton, PA (US); Robin Marie Seifried, Easton, PA (US)

(73) Assignee: SC Supplies, Bath, PA (US)

(21) Appl. No.: 19/277,700

(22) Filed: Jul. 23, 2025

Related U.S. Application Data
(60) Provisional application No. 63/756,884, filed on Feb. 11, 2025.

(51) Int. Cl. A47G 23/06; F16M 11/22

(52) U.S. Cl. CPC A47G 23/0633; A47G 23/0616; F16M 11/22

(57) ABSTRACT

A table caddy used to hold a collection of condiments, sundries, or the like, is formed to include one or more electronic device supports, disposed around the lower perimeter of the caddy. The supports are relatively L-shaped in form and configured to hold an electronic device (e.g., cellphone, tablet, or the like) in place and away from food and drink on the table. The electronic device support allows for an individual to keep his or her device close by so as to still be able to use the device, while also preventing the electronic device from interfering with eating, drinking, or other activities that may be taking place.

### CROSS-REFERENCE TO RELATED APPLICATIONS

This application claims priority from U.S. Provisional Application No. 63/756,884, filed Feb. 11, 2025 and herein incorporated by reference.

### TECHNICAL FIELD

Disclosed herein is a type of table caddy, used for storage of various condiments and/or sundries, that also includes one or more elements configured to support electronic devices in a handy, yet out-of-the-way, location.

### BACKGROUND

In today's society, it is virtually impossible to dine out at a restaurant, bar, or the like without having a cell phone, tablet, or other type of electronic device by your side. Whether to monitor for incoming messages or calls, or to keep young children entertained while waiting for an order, it is typical to have the device either lying on the table, bar or counter-top or propped up in some fashion. Depending on location, it often becomes problematic to keep the device handy once food arrives, while ensuring that food or drink does not spill onto the device.

Even in a residential setting, one's electronic devices may be lying on the table top during a meal or snack, again raising the potential for food or drink to contaminate the devices by an unintentional spill.

### SUMMARY OF THE INVENTION

The problems described above are addressed by the present invention, which relates to a type of table caddy, used for storage of various condiments (and/or sundries) that also includes one or more elements configured to support electronic devices in a handy, yet out-of-the-way, location.

In accordance with the principles of the present invention, a table caddy is formed to include one or more electronic device supports disposed along a lower perimeter area of the base of the caddy. An exemplary electronic device support takes the form of a relatively L-shaped member that is sized to support an electronic device in either a vertical or horizontal orientation. The electronic device support comprises a base member attached to a caddy wall (along the bottom of the wall) and a short vertical element (referred to as an “upright stop”) attached along the distal (far-end) termination of the base member so as to create a trough along one or more sides of the caddy. Upon placement of an electronic device on the base member, the upright stop functions to hold the device against a wall of the caddy without impeding the ability of the user to “upswipe” or otherwise perform tasks on the device.

In one case, the upright stop is configured to exhibit a relatively short vertical dimension that is sufficient to retain the electronic device in place without obstructing one's view of the screen area of the device or impede functionality of the device. As discussed below, two or more electronic device supports may be disposed side-by-side along an edge of a caddy, allowing for multiple electronic devices to be supported along a common side of the table caddy.

It is to be understood that the relatively L-shaped configuration of the electronic device support is only one example; the support may instead be formed to exhibit a slightly rounded J-shaped configuration, a more rounded C-shaped configuration, or any other suitable geometry as long as it comprises a base member extending outward from a caddy side and an upright stop extending vertically from the base member distal termination.

In some embodiments of the present invention, the upright stop is formed to include a “notch” located at approximately the center, exposing additional screen area of a positioned device to easily allow a user to perform an “upswipe” (or other screen functions) from the lowest portion of the display screen. In other embodiments, the upright stop is short enough to allow for the “upswipe” and functionality of the device, while maintaining a height sufficient to function as a stop to support the device in place.

In example embodiments, the inventive table caddy may be designed to exhibit any suitable geometry; that is, square, rectangular, triangular, or any other shape including at least one linear side capable of including the electronic device support. in form, with a separate support element disposed along the lower perimeter of each edge. In other embodiments suitable for “single user” (such as along a bar), the caddy may include one or more support elements disposed along a single side thereof (i.e., the customer-facing side of the caddy).

An exemplary embodiment of the present invention may take the form of a table caddy comprising a bottom surface member having a defined perimeter, a plurality of vertical sides attached to and extending upward from the bottom surface member around the defined perimeter, and at least one electronic device support member. Each vertical side is attached to the bottom surface member, with the attachment location defined as a lower termination of a vertical side. The at least one electronic device support element attached to a vertical side at the lower termination thereof. The at least one electronic device support element is formed to include a base member extending outward from the bottom surface member and at least one upright stop extending vertically from a distal termination of the base member.

Other and further aspects and embodiments of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 is an isometric view of a table caddy system formed in accordance with the present invention, illustrating the use of a pair of support elements to hold a pair of electronic devices;

FIG. 2 is another view of the table caddy of FIG. 1, also illustrating example condiments as stored within the table caddy;

FIG. 3 contains another view of an exemplary table caddy, particularly illustrating example relative dimensions of the caddy, including the support elements;

FIG. 4 illustrates a plurality of support elements, which may be attached to an existing table caddy in accordance with the principles of the present invention.

FIG. 5 is an isometric view of an alternative embodiment of a table caddy formed in accordance with the principles of the present invention;

FIG. 6 is a side view of the embodiment of FIG. 5;

FIG. 7 is a top plan view of an example electronic device support structure, comprising a monolithic element to surround a perimeter of a table caddy and formed to delineate the location of multiple individual electronic device supports;

FIG. 8 depicts an example caddy that may be attached to the electronic device support structure of FIG. 7;

FIG. 9 shows yet another embodiment of the present invention, in this case configured to include only one electronic device support element, such as suitable for use at a bar; and

FIG. 10 shows another electronic device support element configuration that may be used with the bar caddy of FIG. 9.

### DETAILED DESCRIPTION

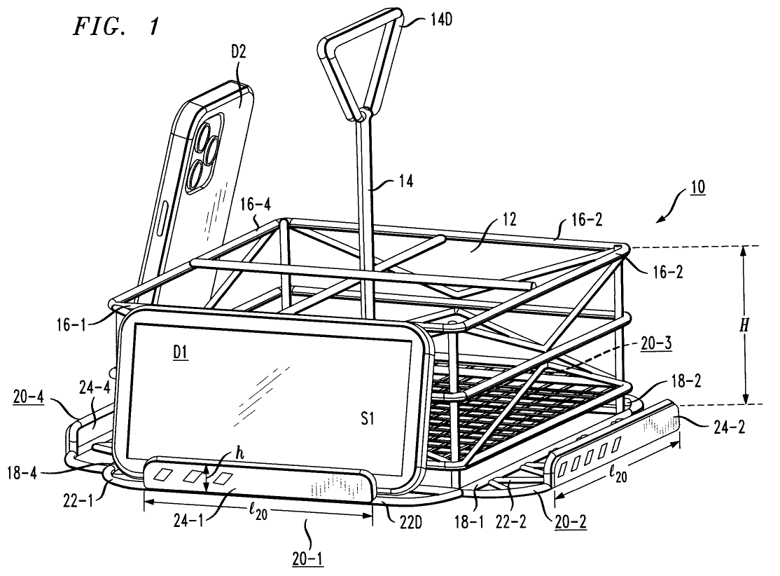

FIG. 1 is an isometric view of an exemplary table caddy 10 formed in accordance with the principles of the present invention. Similar to conventional caddy systems, table caddy 10 includes internal compartments 12 used to store various types of condiments. In some configurations, a central handle 14 (perhaps including a divider 14D) may be included and used to help move caddy 10 from one location to another, as well as to support a placard for items such as a table number, menu items, advertisements, or the like. The embodiment shown here takes the form of a four-sided device, shown as sides 16-1, 16-2, 16-3, and 16-4. A bottom surface 11 is included as well.

In accordance with the principles of the present invention, table caddy 10 also includes a plurality of electronic device supports 20, each support 20-x attached along a lower termination 18-x of an associated caddy side 16-x (here, x=1, 2, 3, 4).

Support 20-2 is clearly shown in the view of FIG. 1 as comprising a relatively L-shaped form in this example, including a base member 22-2 and an upright stop 24-2. Base member 22-2 is shown as attached to lower termination 18-2, with upright stop 24-2 attached to base member 22-2 along its distal edge 22E. Remaining supports 20-1, 20-3, and 20-4 are similarly configured and attached to remaining sides 16 of table caddy 10.

The view of support 20-1 is slightly obstructed in FIG. 1 by the illustration of an exemplary electronic device D1 as positioned therein. As shown, device D1 is oriented in a horizontal position, with the length l₂₀ of support 20-1 shown as sufficient to support a majority of the side edge of device D1. Also evident in this view is the height h of upright stop 24-1, which is designed in accordance with the principles of the present invention as sufficient to secure the position of device D1 against side 16-1 of table caddy 10 without obstructing a user's view of display screen S1 of device D1.

FIG. 1 also illustrates an example positioning of a second electronic device D2 within an electronic device support 20. In this case, second device D2 is placed in a vertical orientation within electronic device support 20-4. The length l₂₀ of support 20-4 is not considered relevant in maintaining the vertical placement of device D2. However, the height H of caddy side 16-4 needs to be sufficient to prevent a device from tipping over into internal compartments 12 but not impairing the functionality of the device while nesting in electronic device support 20-4.

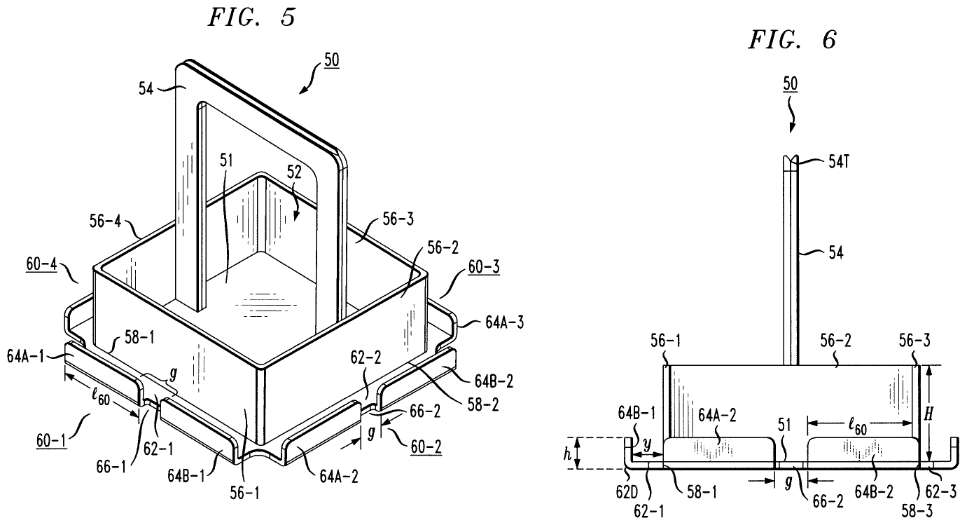

As mentioned above, embodiments of the present invention may be formed to include only one support element attached along a lower termination 18 of a selected side 16 (as discussed below in association with FIGS. 5-8). The embodiment of the present invention as shown in FIG. 1, however, is configured to including a set of four support elements 20-1 through 20-4, used in combination with all four sides 16-1 through 16-4 of table caddy 10.

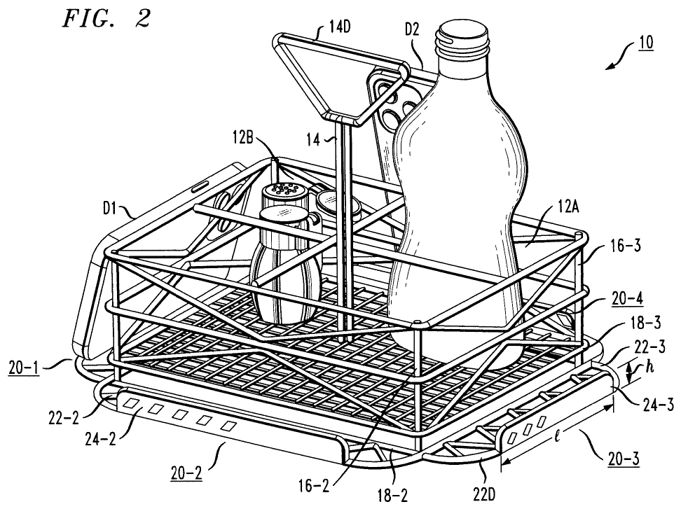

FIG. 2 is another view of table caddy 10, in this orientation clearly illustrating the configuration of electronic device supports 20-2 and 20-3. Also shown in this view is example condiments that may be stored in internal compartments 12A, 12B. Explicitly shown in the view of FIG. 2 are the details of electronic device support 20-3, which were obstructed in the view of FIG. 1. As shown, electronic device support 20-3 is shown as including a base member 22-3 attached to lower termination 18-3 of caddy wall 16-3. An upright stop 24-3 is attached along distal termination 22D of base member 22-3 and extends upwardly a designed height h.

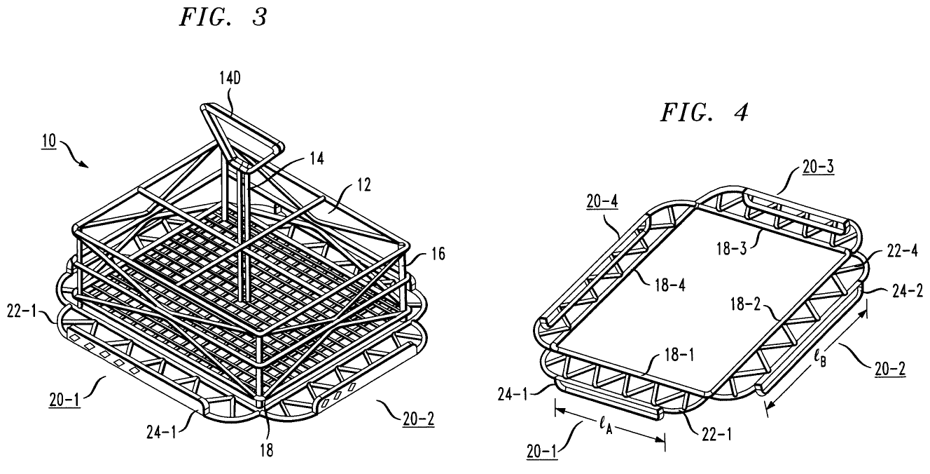

FIG. 3 is an isometric view of table caddy 10 with all example electronic devices (and condiments) removed. FIG. 4 illustrates only an example electronic device portion 20 of table caddy 10, identifying attachment locations as lower terminations 18-1 through 18-4. It is contemplated that in one embodiment support element 20 may be formed as a stand-alone item (such as shown in FIG. 4) and thereafter attached to an existing table caddy. It is further contemplated that each individual support 20 may have a different length. FIG. 4 illustrates this by electronic device support 20-1 formed to exhibit a relatively short length l_{A}, and electronic device support 20-2 formed to exhibit a relatively long length l_{B}. For example, if caddy 10 is rectangular in form, it is conceivable that the supports may be formed of different lengths.

It is also to be understood that the particular wire-frame form of table caddy 10 as depicted in FIGS. 1-4 is exemplary only. Various other configurations and/or material choices for the caddy itself are considered to fall within the scope of the present invention as long as the caddy is formed to include at least one electronic device support attached along a bottom edge to support an electronic device.

For example, FIG. 5 is an isometric view of an alternative table caddy 50 also formed in accordance with the principles of the present invention. In this particular embodiment, the elements of table caddy 50 are formed of a solid material, such as a plastic, to create a light-weight table caddy that may be repeatably cleaned/washed, as needed. Other material choices may include, but are not limited to, glass, metal, wood, or any combination thereof.

Similar to table caddy 10 described above, table caddy 50 is shown as having a bottom surface 51 and an interior compartment 52 for storing condiments, napkins, etc. A handle 54 is also included in this embodiment. Again, this particular caddy is depicted as a four-sided structure, including a set of four sides 56-1, 56-1, 56-3, and 56-4. Each side 56-x is defined as including a lower termination 58-x (only lower terminations 58-1, 58-2 visible in the isometric view of FIG. 5).

In accordance with the principles of the present invention, table caddy 50 is formed to include at least one electronic device support 60. In this particular configuration, a set of four electronic device supports 60-1, 60-2, 60-3, and 60-4 is shown, with each support 60-x attached along a lower termination 58-x of an associated caddy wall 56-x. Similar to electronic device support 20 described above, alternative electronic device support 60 may be relatively L-shaped in form. Support 60-1 is shown in FIG. 5 as including a base member 62-1, which is attached to side 56-1 along lower termination 58-1. In this case, and in contrast to the configuration shown in FIGS. 1-4, the vertical component of electronic device support 60 comprises a pair of upright stops, denoted as a first upright stop 64A-1 and a second upright stop 64B-1. A notch 66-1 of an exemplary length g is shown as included between first upright stop 64A-1 and second upright stop 64B-1. A pair of upright stops 64A-2, 64B-2 is shown as included in support 60-2 as well. As mentioned above, preferred embodiments of the present invention may include a notch (also referred to perhaps as a “gap”) along an upright stop so as to expose a lower portion of the screen area. The ability to include this opening allows for an individual to easily use finger controls to “upswipe,” text, or perform other functions on a positioned electronic device without having to remove it from the cradled position on the caddy.

FIG. 6 is a side view of alternative table caddy 50 of FIG. 5. The relative size of the elements forming caddy 50 (while not to scale) are best shown in this view. In particular, an example base member 62-1 is shown as extending a distance y outward from associated side 56-1. Illustrated upright stop 64B-1 is shown as attached to base member 62-1 along its distal termination 62D, with upright stop 64B-1 (as well as all other upright stops 64) having a selected height h determined to be sufficient to support an electronic device positioned on base member 62-1. An example side height H is also shown in this view, where as mentioned above the sides of the inventive caddy need to be tall enough to prevent an electronic device from tipping over into interior compartment 52 but not impairing the functionality of the device while nesting in the trough. In this view of FIG. 6, handle 54 is shown as having a divided top termination 54T, which again can be used to position an inserted card, menu, etc.

In accordance with this alternative embodiment, therefore, an exemplary support 60 of table caddy 50 may be used to support multiple electronic devices along a single side 56. Moreover, it is contemplated that each upright stop 64 may be formed of a length l₆₀ sufficient to support a device in either a vertical or horizontal orientation.

Alternatively, it is contemplated that an arrangement may use stop lengths of a somewhat smaller dimension, where the combination of both stops allows for a relatively larger device (for example, a tablet) to be securely held in place.

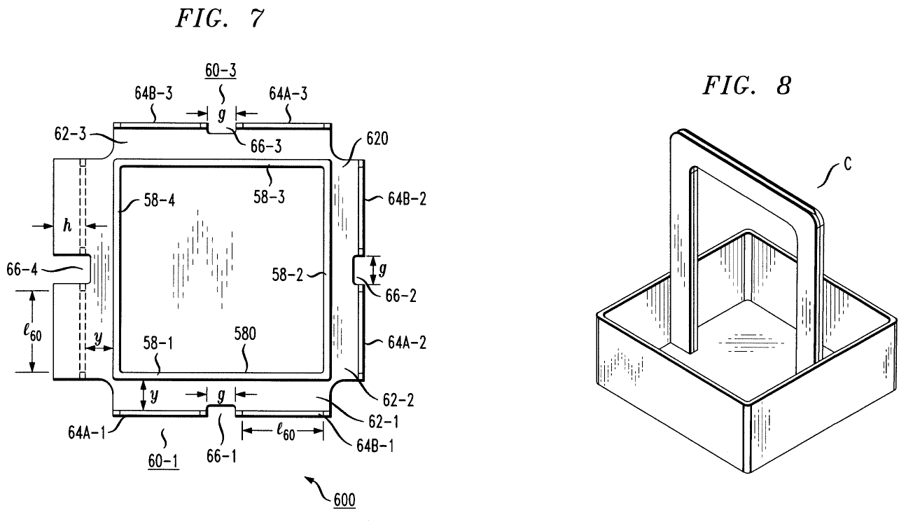

It is contemplated that in formation of table caddy 50 as shown in FIGS. 5 and 6, the set of base members 62 may be formed as a single, monolithic component. FIG. 7 is a top view of an exemplary electronic device support structure 600 which illustrates this monolithic form. In particular, a continuous base member 620 is formed to include a set of identifiable sections 62-1, 62-2, 62-3, and 62-4, yet may be formed as a single piece of material. An inner perimeter 580 is shown and defined as lower terminations 58-1 through 58-4.

Depending on materials, construction and assembly methods that may be used, upright stops 64A, 64B may be initially formed as extensions of an associated base member 62. This is illustrated for upright stops 64A-4, 64B-4 in FIG. 7, where a following step in manufacture may be to “fold” stops 64 upward along the dotted line shown as defining the demarcation between the outward extent y of base member 62 and the vertical height h of associated upright stop 64.

As with the embodiment discussed above in association with FIGS. 1-4, the ability to manufacture electronic device support structure 600 as a separate component may allow for it to be used with a conventional caddy C (as illustrated in FIG. 8), merely by attaching caddy C around interior perimeter 580. Alternatively, support structure 600 may be formed to include bottom surface 51 of caddy 50 (as shown in FIGS. 5 and 6), such that in assembly only sides 56 need to be affixed to inner perimeter 580.

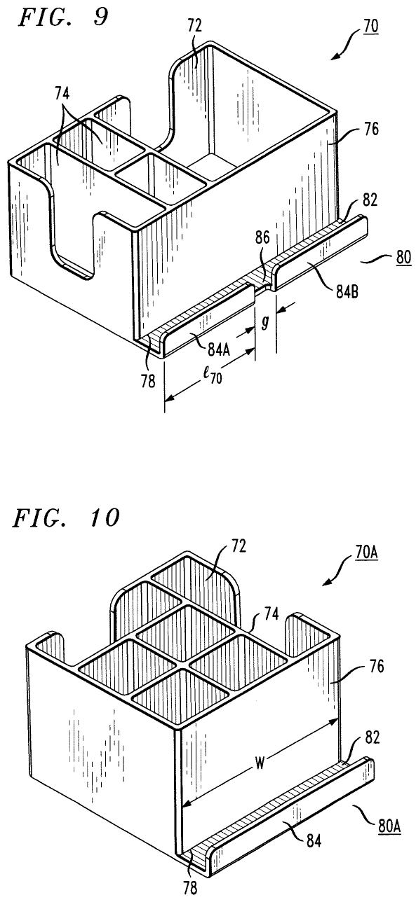

FIG. 9 is an isometric view of yet another type of table caddy formed in accordance with the principles of the present invention. For illustrative purposes, the illustrated caddy is referred to as a “bar caddy” 70. The reference to “bar caddy” is simply to identify an example configuration of the present invention that may be used at a bar, where only a single customer-facing electronic device support may be necessary. Here, bar caddy 70 again includes an interior compartment 72 for holding condiments and the like. A pair of internal dividers 74 is used in this example to delineate various sections within bar caddy 70. For the sake of illustrating various alternatives, bar caddy 70 is shown as not requiring a handle (where the handle is indeed considered as an optional component in all embodiments of the present invention).

As shown in FIG. 9, bar caddy 70 is formed to include at least one side 76 along which it is desired to include an electronic device support formed in accordance with the principles of the present invention. As shown in FIG. 9, side 76 includes a lower termination 78, with an electronic device support 80 shown as attached to sidewall 76 along lower termination 78. Here, electronic device support element 80 is shown as comprising a base member 82 and a pair of upright stops 84A and 84B (with a notch 86, of a width “g,” as shown, between upright stop 84A and upright stop 84B).

Of course, the bar caddy arrangement of FIG. 9 may also utilize single upright stop as part of electronic device support 80. FIG. 10 illustrates this particular configuration as a bar caddy 70A, including an electronic device support 80A including only a single upright stop 84 (that is, without the inclusion of a notch). Here, upright stop 84 is depicted as extending across substantially the complete width W of side 76 (as well as base member 82).

The foregoing discussion discloses and describes merely exemplary embodiments of the present invention for purposes of illustration only. One skilled in the art will readily recognize from such discussion, as well as from the accompanying drawing and claims, that various changes, modifications, and variations, and applications to other containers designed to hold household items, toiletries, school supplies, other sundries and the like can be made therein without departing from the spirit and scope of the invention as defined in the following claims.

What is claimed is:

1. A table caddy comprising:
a bottom surface member having a defined perimeter;
a plurality of vertical sides attached to and extending upward from the bottom surface member around the defined perimeter, each vertical side attached to the bottom surface member, the attachment location defined as a lower termination of a vertical side; and
at least one electronic device support element attached to a vertical side at the lower termination thereof, the at least one electronic device support element including a base member extending outward from the bottom surface member and at least one upright stop extending vertically from a distal termination of the base member.

2. The table caddy as defined in claim 1, wherein the at least one upright stop exhibits a length l sufficient to support an electronic device positioned in a horizontal direction within the at least one electronic device support element..

3. The table caddy as defined in claim 1, wherein the at least one upright stop exhibits a height h selected to prevent blockage of a screen portion of a positioned electronic device.

4. The table caddy as defined in claim 1, wherein each vertical side exhibits a height H sufficient to support an electronic device in a stationary position without impairing functionality of the electronic device.

5. The table caddy as defined in claim 1, including a single electronic device support.

6. The table caddy as defined in claim 1, including a plurality of electronic device supports.

7. The table caddy as defined in claim 1, wherein at least one electronic device support comprises a plurality of individual upright stops attached along the distal termination of the associated base member, at least two adjacent upright stops separated by a defined notch having a gap spacing “g” to allow functionality of a supported electronic device.

8. The table caddy as defined in claim 7, wherein the at least one electronic device support comprises a pair of upright stops attached in a spaced-apart configuration to the distal termination of the associated base member, with a notch formed between the pair of upright stops so as to expose a lower portion of a supported electronic device display area and provide access for functions such as swiping up on the display area.

9. The table caddy as defined in claim 1, wherein the bottom surface member is rectangular in form and exhibits a set of four lower terminating edges, the plurality of vertical sides joined to the bottom member along each lower termination of the set of four lower terminations.

10. The table caddy as defined in claim 9, wherein the at least one support comprises a single support element attached in proximity to a first lower termination of the set of four lower terminations.

11. The table caddy as defined in claim 9, wherein the at least one support element comprises a set of four individual support elements, each attached in proximity to a separate one of the set of four lower terminating edges in a one-to-one relationship.

12. The table caddy as defined in claim 1, wherein the at least one support element is substantially L-shaped in form.
